(19) United States
(12) Patent Application Publication
(10) Pub. No.: US 2012/0126102 A1
(43) Pub. Date: May 24, 2012

(54) Optical Encoder

(75) Inventor: Jean-Louis Bigand, Vendome (FR)

(73) Assignee: Thales, Neuilly-sur-Seine (FR)

(21) Appl. No.: 13/123,478

(22) PCT Filed: Oct. 9, 2009
(86) PCT No.: PCT/EP2009/063227

§ 371 Date: Sep. 7, 2011

(30) Foreign Application Priority Data
Oct. 10, 2008 (FR) 0805614

(51) Int. Cl. G01D 5/347

(52) U.S. Cl. 250/231.1

(57) ABSTRACT

Optical encoders supply binary logic signals representing the relative position increments of two elements of the encoder, the two elements being mobile relative to one another. The first element bears at least one mark and the second element bears a pair of detection cells for detecting the mark. The dimensions of the mark are defined so that said mark can be detected either by neither of the two cells, or by a single cell or by both cells. The invention is well suited to angular encoders, and makes it possible to widen the manufacturing tolerances of the marks on the first element and on the relative position of the two cells.

The invention relates to the optical encoders that supply binary logic signals representing relative position increments of two elements of the encoder, the two elements being mobile relative to one another. These optical encoders, for example angular encoders, are used like potentiometers, for example for the manual control of electronic equipments sensitive to an input parameter that can vary continuously or almost continuously, but they are much more reliable than potentiometers. Typically, in an application for aeronautical equipment, it is possible to use an optical angular encoder to indicate to an automatic piloting computer an altitude or speed setpoint that the pilot chooses by actuating a control knob which rotates the encoder. The reliability of the encoder and of the information that it delivers is then a key element of the encoder.

An optical angular encoder is typically made up of a disk bearing regular marks, this disk being operated in rotation by a control knob (manual for example). A photoelectric cell fixed in front of the disk detects the scrolling of the successive marks when the control knob rotates the disk. The marks are typically openings in an opaque disk, a light-emitting diode being placed on one side of the disk and the photoelectric cell being placed on the other side.

Each passage of a mark constitutes an increment of one unit in counting the rotation of the disk. The angular resolution is determined by the angular pitch of the marks which are arranged regularly over one disk revolution. To detect both increments and decrements of rotation angle when the rotation direction is reversed, two photoelectric cells are provided that are physically offset by an odd number of quarter pitches between them. Thus, the lit/unlit logic states of the two cells are coded on two bits which successively assume the following four values: 00, 01, 11, 10 when the disk rotates in one direction and the following four successive values 00, 10, 11, 01 when the disk rotates in the other direction, so that it is easy to determine, not only the occurrence of a rotation increment (change of state of one of the bits) but also the direction of rotation (by comparison between a state of the cells and the immediately prior state).

The encoders require high precision in their construction. Notably, the relative position of the photoelectric cells must be a function of the increment pitch. The same applies for the disk for which the dimensions and the position of each opening must be related to those of the photoelectric cells.

The invention aims to simplify the production of an optical encoder by widening the manufacturing tolerances for certain elements of the encoder, notably the positioning tolerances of the photoelectric cells and the tolerances on the dimensions and the positions of the openings in the disk.

To this end, the subject of the invention is an incremental optical encoder, comprising two elements mobile relative to one another, the first element bearing at least one mark and the second element bearing a pair of detection cells for detecting the mark, characterized in that the dimensions of the mark are defined so that said mark can be detected either by neither of the two cells, or by a single cell or by both cells and in that a length of an area of the second element including the pair of detection cells is less than a length of the mark, the lengths being measured in the direction of the relative displacement of the two elements.

The lengths of the area and of the mark may be a distance if the relative movement of the two elements is linear. The lengths may be angular if the relative movement is rotational.

The manufacturing tolerance for the mark is widened. In fact, the minimum length of the mark is the length of the area. However, the maximum length of the mark is not linked to the length of the area but is only a function of the number of increments of the encoder.

Successive increments of the encoder are, for example, defined by the detection of the mark:
by neither of the cells,
then by a first of the cells,
then by both cells simultaneously.

The increments succeeding the one defined by the detection of the mark by both cells simultaneously are, for example, defined by the detection of the mark:
by the second of the cells,
then by neither of the cells.

The invention will be better understood and other advantages will become apparent from reading the detailed description of an embodiment given as an example, the description being illustrated by the appended drawing in which:

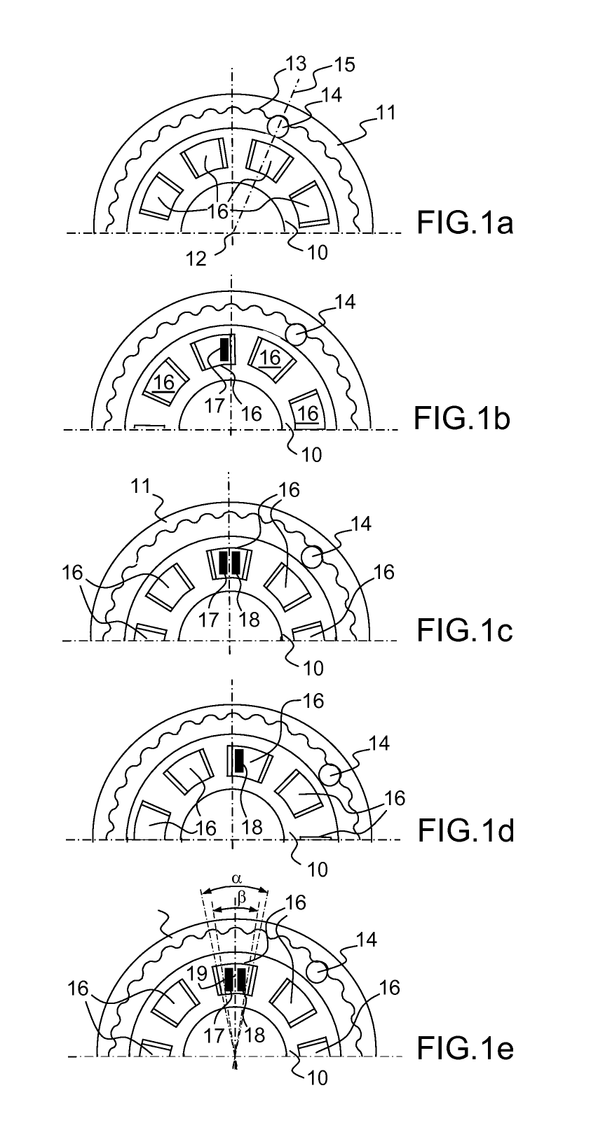

FIGS. 1a to 1d represent different relative positions of two elements, mobile relative to one another, of an angular encoder according to the invention;

FIG. 1e specifies the relative lengths of a mark of a first element relative to an area including cells for detecting the mark;

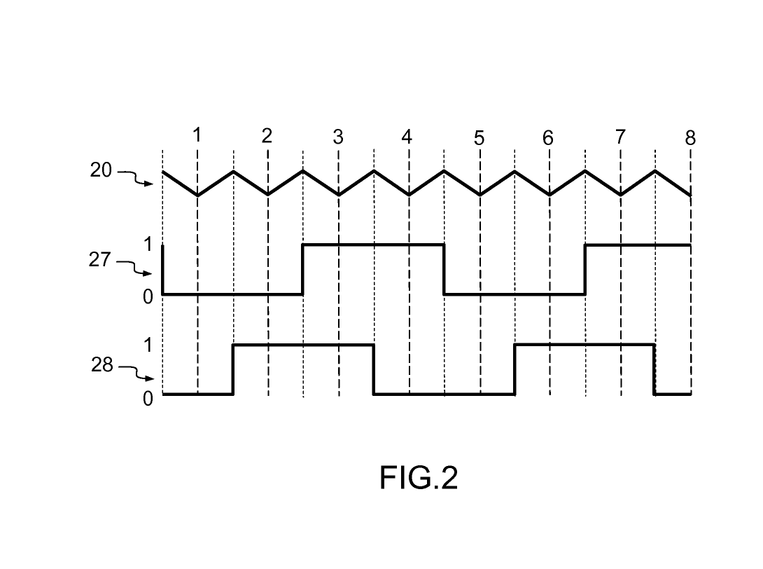

FIG. 2 represents the encoding obtained by two detection cells of a encoder;

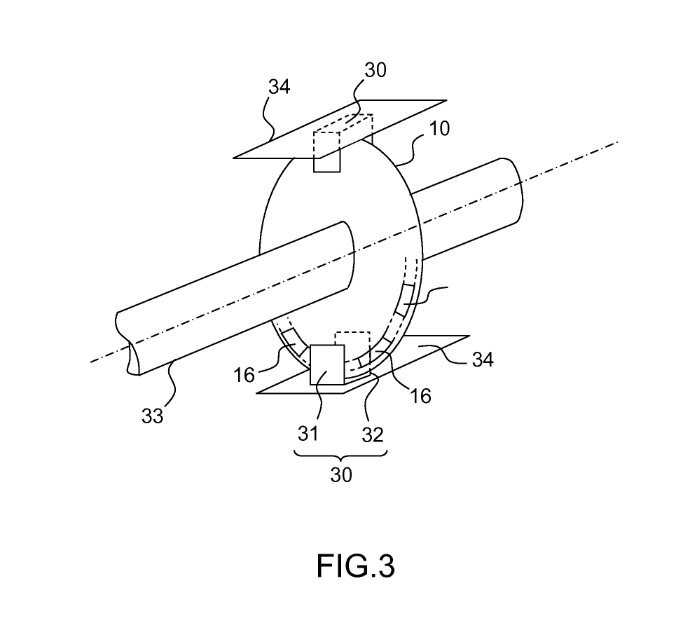

FIG. 3 represents, in perspective, an exemplary embodiment of an angular encoder.

For the sake of clarity, the same elements are given the same references in the various figures.

The following description is given in relation to an angular encoder. Obviously, it is possible to implement the invention in a linear encoder.

FIGS. 1a to 1d represent four positions of an angular encoder comprising two elements 10 and 11 that are mobile relative to one another. The first element is a disk 10 that is mobile in rotation about an axis 12. The second element 11 forms a casing for the encoder. The axis 12 is, for example, linked to a rotary knob that a user can operate to enter a binary datum by means of the encoder. The encoder makes it possible to determine the angular position of the disk 10 relative to the casing 11 when the disk 10 is rotating about the axis 12, according to an increment pitch.

Advantageously, the encoder comprises means for mechanically defining stable positions of the two elements 10 and 11 relative to one another. In the case of an angular encoder, these means comprise, for example, a toothed internal wheel 13 secured to the casing 11 and a ball 14 linked to the disk 10. The ball 14 is free in translation relative to the disk 10 in a radial direction 15 of the disk 10. The ball 14 can be displaced from one notch to another of the wheel 13. The ball 14 can be pushed by a spring, which is not represented, to keep it at the bottom of each notch. The stable positions of the disk 10 relative to the casing 11 are defined by the positions of the ball 14 at the bottom of each notch of the wheel 13.

The disk 10 comprises a succession of openings 16 between which the disk 10 is solid. Each opening 16 forms a mark on the disk 10 and the solid space separating each opening form an absence of mark. In other words, the disk 10 comprises an alternating succession of marks 16 and of absences of marks. The marks are arranged radially about the axis 12. It is also possible to produce the disk 10 in a solid material without openings by radially alternating transparent areas forming the marks and opaque areas. Consequently, the transparent areas can be likened to the opening 16. Obviously, the invention can be implemented on the basis of a single mark produced on the disk 10.

The casing 11 comprises a pair of cells 17 and 18 for detecting the mark 16. In the example considered, the encoder also comprises an optical emitter that is able to be detected separately by the two detection cells 17 and 18. As a variant, the encoder may comprise two optical emitters that are each able to be detected by one of the detection cells 17 or 18. The disk 10 may be displaced between the emitter(s) on the one hand and the cells 17 and 18 on the other hand. The emitter(s) is (are) for example light-emitting diodes and the cells 17 and 18 are photodiodes sensitive to the radiation emitted by the diode(s). In the variant in which the encoder comprises two light-emitting diodes, it is important for each cell 17 or 18 to be sensitive only to a single diode.

The need for separate detection by each of the cells 17 and 18 makes it possible to define a minimum distance between the cells 17 and 18 on the one hand and possibly the diodes on the other hand. This distance should allow for a mark 16 to be able to be detected either by none or by one or by both of the cells 17 and 18. In other words, it is essential for an edge of the mark 16 to be able to be stopped between the two cells 17 and 18 during the rotation of the disk 10. In the presence of an alternating succession of marks 16 and absence of marks 16, the pair of cells 17 and 18 is able to detect each mark 16 independently of the next. The detection of the mark 16 is done on an edge thereof. The length of the mark 16 therefore has no influence on the detection of the mark 16. It is therefore possible to widen the manufacturing tolerances for the mark 16. The maximum limit of the length of the mark 16 is only a function of the number of increments of the encoder. FIG. 1e is an enlarged view of FIG. 1c in which the angular length α of the mark 16 is represented and should be greater than an angular length β of an area 19 including the pair of detection cells 17 and 18. In other words, the area 19 is the minimum surface area occupied by the two detection cells 17 and 18 including the space situated between the cells 17 and 18.

However, implementing the invention does not lead to any maximum limit for the distance between the cells 17 and 18. A maximum limit exists only for positioning the sufficient number of increments on the disk 10.

Furthermore, the relative position of the two cells 17 and 18 is not a function of the number of increments. It is therefore possible to standardize a support for the cells 17 and 18 for different encoders that do not have the same number of increments.

During the movement of the disk 10 around of its axis 12, each cell 17 and 18 receives or does not receive the radiation emitted by the associated diode according to the presence or absence of an opening 16 between the cell 17 or 18 and its associated diode.

In FIG. 1a, the two cells 17 and 18 are masked by the disk 10. In FIG. 1b, the cell 17 is lit and the cell 18 is masked. In FIG. 1c, the two cells 17 and 18 are lit. In FIG. 1d, the cell 17 is masked and the cell 18 is lit.

The four FIGS. 1a to 1d represent, in order, four successive stable positions in the rotation of the disk 10 around of the axis 12 in the clockwise direction. In the position which follows the one represented in FIG. 1d, the disk masks the two cells 17 and 18. This position is equivalent to that of FIG. 1a. It is obviously possible to have the disk rotate in the counterclockwise direction. A succession that is the reverse in the order of lighting and masking of the cells 17 and 18 would then be obtained.

FIG. 2 represents the encoding obtained by the two detection cells 17 and 18 according to the stable positions of the disk 10 relative to the casing 11. Eight stable positions, numbered from 1 to 8, are represented in the top part of FIG. 2. A broken line 20, in sawtooth form, represents the notches of the wheel 13. A curve 27 represents the encoding obtained by means of the cell 17 and a curve 28 represents the encoding obtained by means of the cell 18. The encoding deriving from the cells 17 and 18 is binary and can assume two values denoted 0 and 1. The encoding deriving from the cell 17 takes the value 0 for the positions 1, 2, 5 and 6 and the value 1 for the positions 3, 4, 7 and 8. The encoding deriving from the cell 18 takes the value 0 for the positions 1, 4, 5 and 8 and the value 1 for the positions 2, 3, 6 and 7.

The positions 1 and 5 correspond to those represented in FIG. 1a. The positions 2 and 6 correspond to those represented in FIG. 1d. The positions 3 and 7 correspond to those represented in FIG. 1c. The positions 4 and 8 correspond to those represented in FIG. 1b. The order of succession of the positions 1 to 8 corresponds to a rotation of the disk 10 in the counterclockwise direction as defined by means of FIGS. 1a to 1d.

FIG. 3 represents, in perspective, an exemplary embodiment of an angular encoder comprising two emitters and two cells 17 and 18 secured to a U-shaped support 30. The support 30 comprises two facing branches 31 and 32. The emitters are located on one of the branches 31 of the U and the cells 17 and 18 are located on the other branch 32 of the U. The disk 10 is displaced between the branches of the U. When the disk 10 rotates about its axis 12, the openings 16 pass between the branches of the support 30 so as to be able to be detected by the cells 17 and 18. A shaft 33 extending along the axis 12 is secured to the disk 10. The shaft 33 is linked to the casing 11 by means of a bearing allowing a degree of freedom in rotation about the axis 12. The shaft 33 enables an operator to rotate the disk 10.

Advantageously, the support 30 is secured to a printed circuit card 34 making it possible to provide the connections necessary to the operation of the emitters and of the cells 17 and 18. It is also possible to arrange on the card 34 electronic components linked to the processing of the encoding deriving from the cells 17 and 18. The card 34 is, for example, located in a plane parallel to the axis 12.

Advantageously, to provide redundancy in the encoding, the support 30 can be duplicated. The second support 30 also supports two emitters and two cells 17 and 18. The second support 30 may also be arranged on a printed circuit card 34. To improve the compactness of the encoder, the two cards 34 may be parallel. Expressed in more general terms, the encoder comprises two second elements that are mobile relative to a single first element bearing at least two marks, each of the two second elements bearing a pair of cells for detecting one of the two marks so as to provide redundancy in the detection of the marks. In fact, the cards 34 have a level of reliability that is less than that of the disk 10. To improve the reliability of the encoder, it is sufficient to duplicate the cards 34 about a single disk 10. This duplication may also be used to detect a failure of the components on the card 34 when the encoding delivered by each of the pairs of cells 17 and 18 becomes different.

1. An incremental optical encoder, comprising:
two elements mobile relative to one another, the first element bearing at least one mark and the second element bearing a pair of detection cells for detecting the mark, wherein the dimensions of the mark are defined so that said mark can be detected either by neither of the two cells, or by a single cell or by both cells, wherein a length of an area of the second element including the pair of detection cells is less than a length of the mark, the lengths being measured in the direction of the relative displacement of the two elements, and
wherein the manufacturing tolerance in the length of the mark is included between a minimum length equal to the length of the area and a maximum length of the mark that is independent of the length of the area and a function of the number of increments of the encoder.

2. (canceled)

3. The encoder as claimed in claim 1, wherein the successive increments of the encoder are defined by detection of the mark:
by neither of the cells,
then by a first of the cells,
then by both cells simultaneously.

4. The encoder as claimed in claim 3, wherein the increments succeeding the one defined by the detection of the mark by both cells simultaneously are defined by the detection of the mark:
by the second of the cells,
then by neither of the cells.

5. The encoder as claimed in claim 1, wherein the first element comprises an alternating succession of marks and absence of marks.

6. The encoder as claimed in claim 1, being an angular encoder, the first element being a disk that is mobile in rotation relative to the second element.

7. The encoder as claimed in claim 1, wherein the mark is an opening in the first element, the second element comprises one or two optical emitters capable of each being detected by one of the detection cells and wherein the first element can be displaced between the emitter(s) on the one hand and the cells on the other hand.

8. The encoder as claimed in claim 7, wherein the emitter(s) and the cells are secured to a U-shaped support, the support comprising two facing branches, the emitter(s) being located on one of the branches of the U and the cells are located on the other branch of the U and in that the first element is displaced between the branches of the U.

9. The encoder as claimed in claim 8, wherein the support is secured to a printed circuit card.

10. The encoder as claimed in claim 1, further comprising two second elements that are mobile relative to a single first element bearing at least two marks, each of the two second elements bearing a pair of detection cells for detecting one of the two marks so as to provide redundancy in detection of the marks.

11. The encoder as claimed in claim 1, further comprising means for mechanically defining stable positions of the two elements relative to one another and in that, in a first stable position, neither of the two cells detects the mark, in a second stable position, a single cell detects the mark and in a third stable position, both cells detect the mark.
